(19) United States
(12) Patent Application Publication
(10) Pub. No.: US 2001/0055523 A1
(43) Pub. Date: Dec. 27, 2001

(54) VERTICLE LIFTING AND MOVING

(76) Inventors: HENRY M. SLODDEN, HINGHAM, MA (US); KEITH R. BELLOWS, MIDDLEBORO, MA (US)

Correspondence Address: JOHN J GAGEL, FISH & RICHARDSON P C, 225 FRANKLIN STREET, BOSTON, MA, 021102804

(21) Appl. No.: 09/449,376

(22) Filed: Nov. 24, 1999

(51) Int. Cl. B60P 3/00; B65G 1/00

(52) U.S. Cl. 414/458; 414/608

(57) ABSTRACT

A vertical lifting rack and methods of moving items, such as industrial shelving.

### FIELD OF THE INVENTION

This invention relates to vertically lifting and moving articles, particularly industrial shelving.

### BACKGROUND

In many commercial environments, inventory is stored on industrial shelving. This shelving typically includes a series of vertical support posts between which shelves are suspended, usually on pins, that extend through holes in the support posts. When the time comes to move the inventory, for example to reorganize a warehouse or move the inventory to a different warehouse, typically the items on the shelves are removed and packaged, the shelving is moved to a new location, and then the items are unpackaged and placed back on the shelves so that they can be accessed as part of the commercial enterprise.

In Carraway U.S. Pat. No. 2,822,948, a rack is proposed which may permit relocation of shelving. The rack is positioned over the top of the shelving to lift the shelving vertically using a forklift. The rack is attached to the shelving by a series of metal straps that can be bolted or hooked to the shelving.

### SUMMARY OF THE INVENTION

The inventions relate to vertically lifting items, such as industrial shelving, by techniques that may reduce the labor involved and the chance of items falling from the shelving during lifting and moving.

In one aspect, the invention relates to a lifting rack that is arranged to be positioned above an article to be lifted. The rack includes a compression grasper for attachment to the article when the rack is positioned thereover and capable of maintaining attachment as the article is lifted. An advantage of such a rack is that the compression grasper is easily attached to the shelving or other article, without time consuming steps of bolting the rack to the article or requiring specialized components sized to fit the article for attachment. Moreover, such a system is typically more stable than hooks and does not require that the hook size be compatible with the shelving configuration.

Embodiments may include one or more of the following. Prior to lifting the shelving, a wrap is provided around portions of the shelving. The shelving is placed on a rolling dolly. The shelving is rolled to a new location. The shelving is rolled into a vehicle. The shelving is lifted from the rolling dolly. The grasper includes a moveable compression element that increases compression force as the article is lifted vertically. The grasper includes a single moveable compression element that provides compression force against a non-moveable surface. The shelving is open shelving, including a series of metal posts with shelves suspended therefrom. The moveable element is a pivoting element. The rack is forklift compatible.

The invention also includes additional features of the rack, e.g. for stabilizing lifting, a lifting vehicle including a rack, and techniques for lifting specific shelving types, including wrapping the shelving prior to lifting, as described below. In certain aspects, hooks or bolt components instead of compression graspers, may be used.

The inventions may provide one or more of the following advantages. Attaching the lifting rack to the shelving or other item can be greatly simplified and can reduce the time and effort of moving personnel. For example, compression graspers can typically grasp items that have a range of thicknesses and physical shapes, thus reducing the need for varying the attachment mechanism based the particular item to be moved or requiring item-specific bolting arrangements. The inventions also provide for a relatively stable lifting motion which reduces product loss from the shelves during lifting. Moreover, wrapping the shelving, particularly open shelving, may substantially enhance the rigidity of weak shelving, thus reducing the chance of loss during lifting.

Still further features, aspects, and advantages follow.

### DESCRIPTION OF THE PREFERRED EMBODIMENT

We first briefly describe the drawings.

Drawings

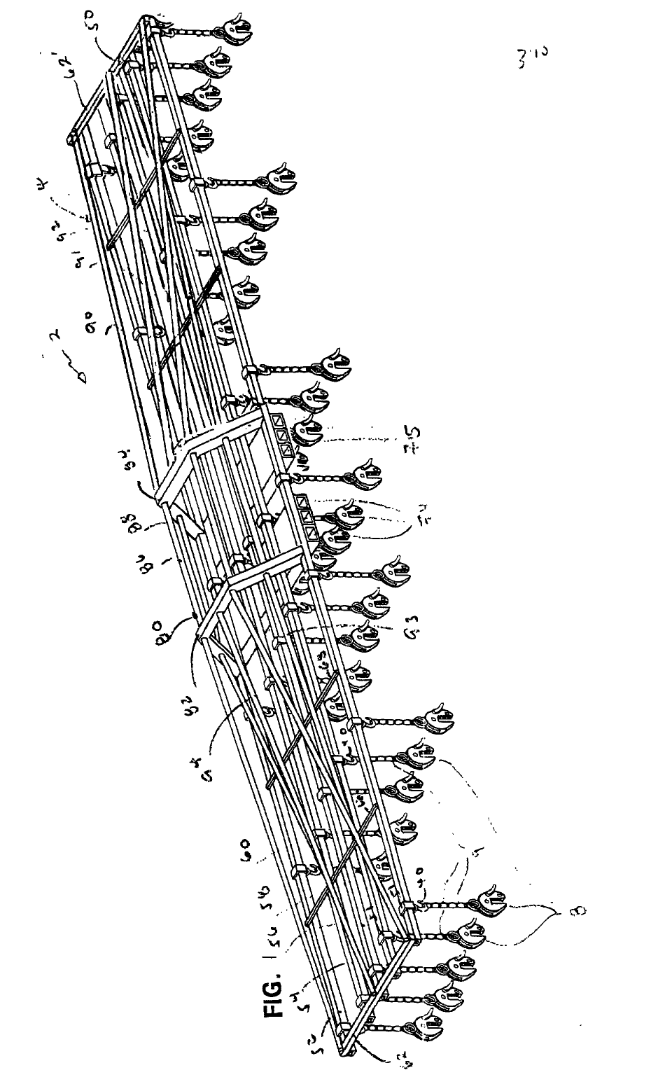

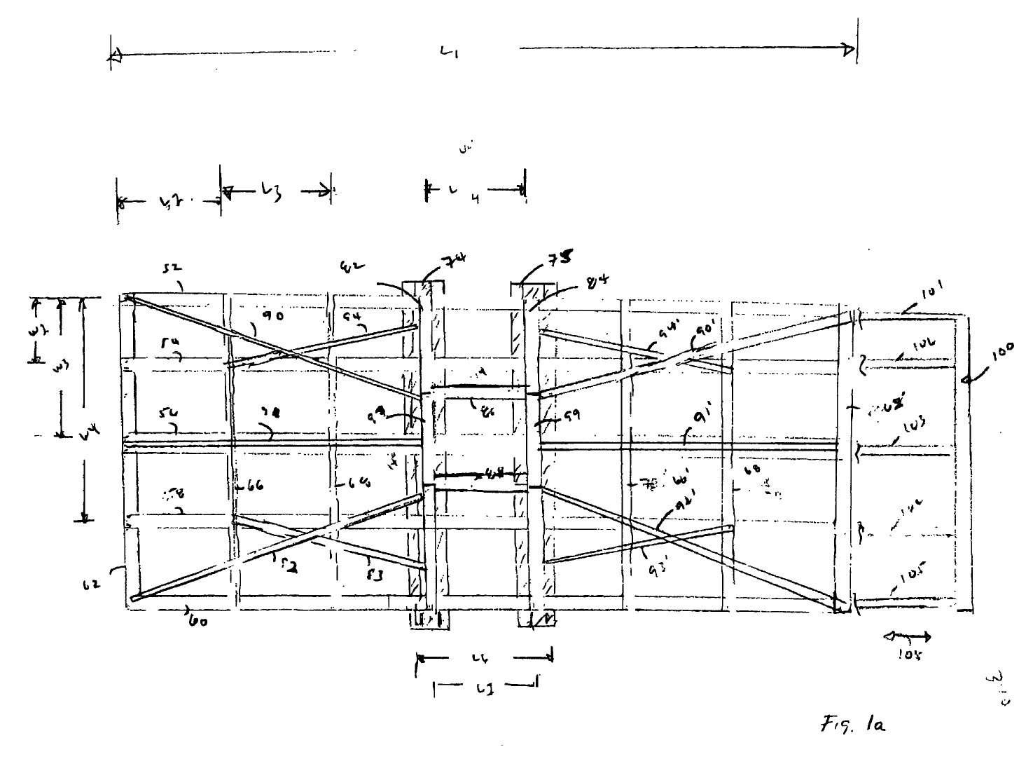

FIG. 1 is a perspective view of a vertical lifting rack including compression graspers and FIG. 1a is a top view of the rack;

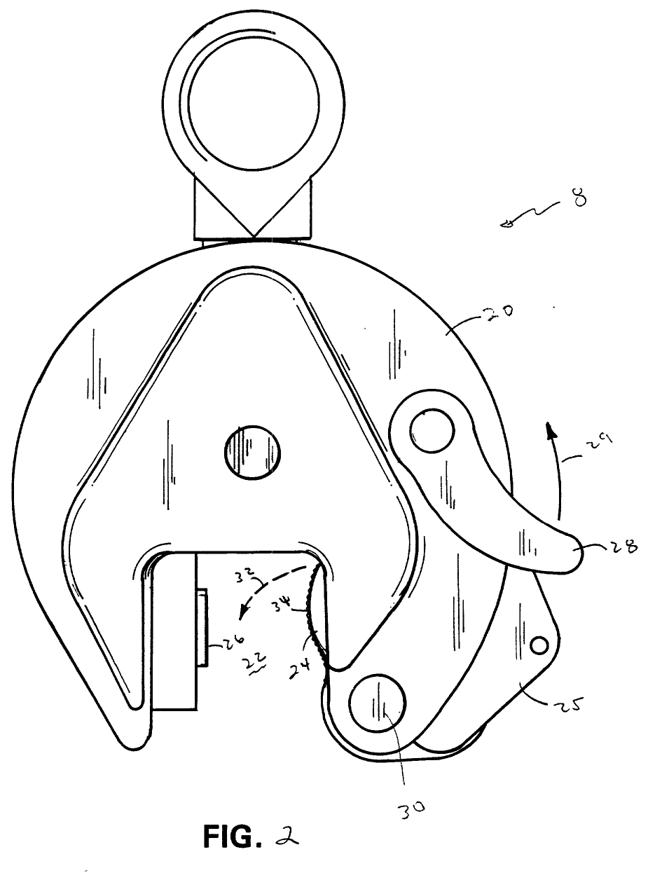

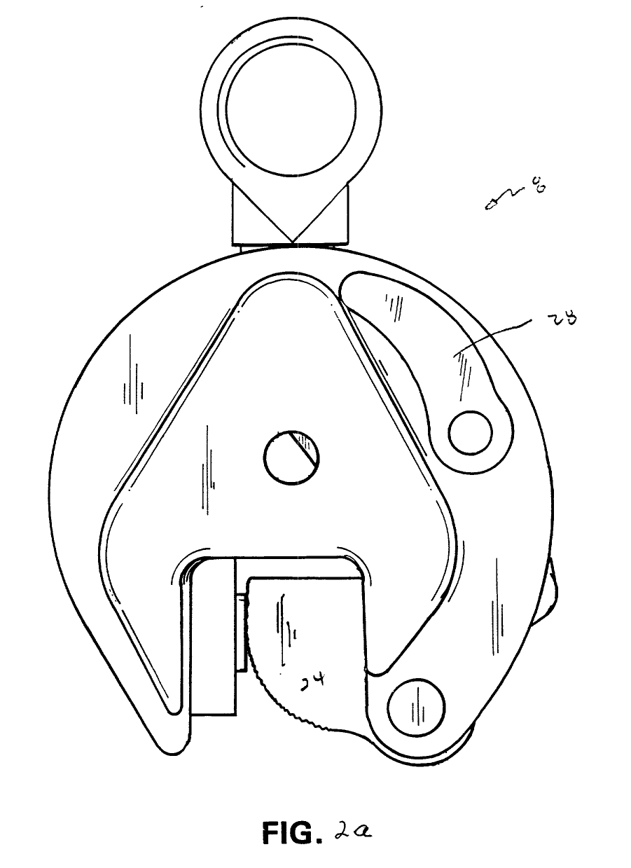

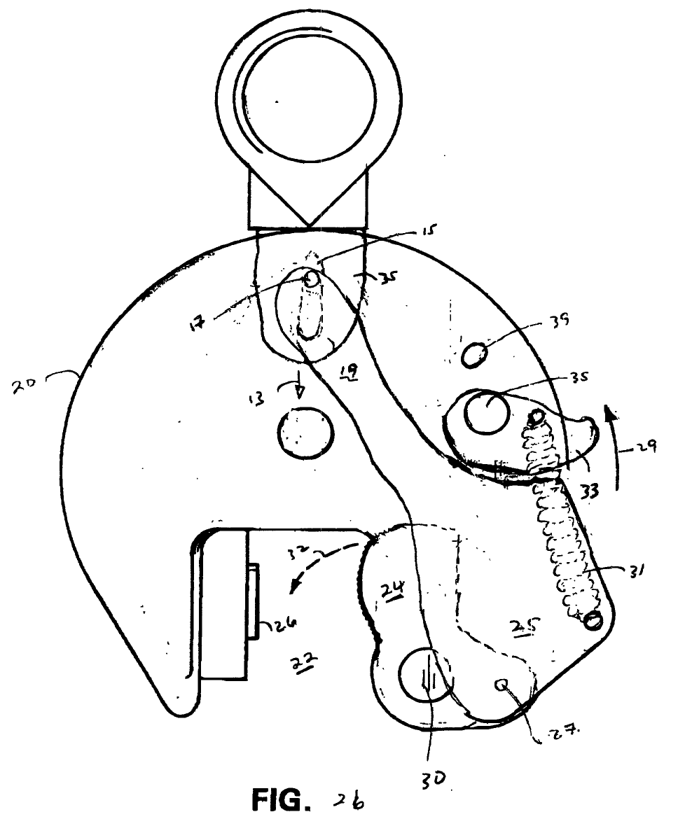

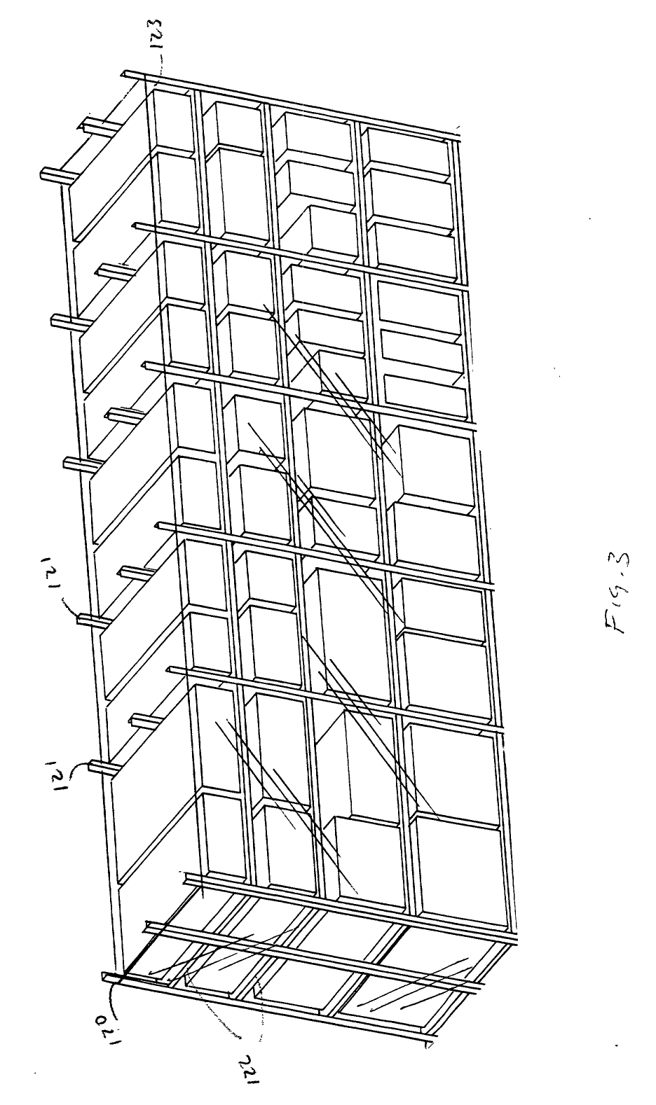

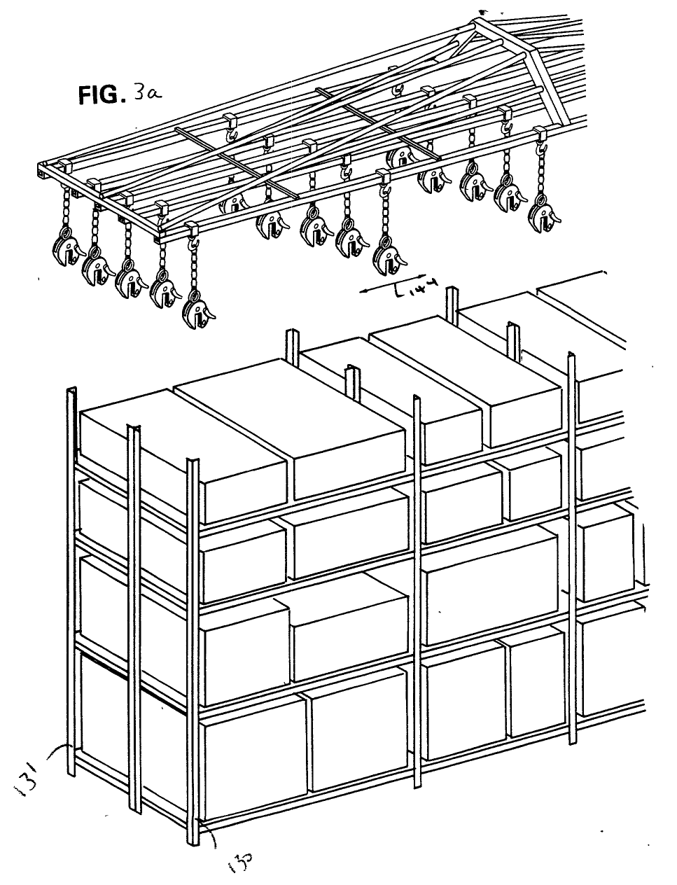

FIG. 2 is an enlarged view of an embodiment of a compression grasper with the grasper in the open position, while FIG. 2a is a similar view with the grasper in the closed condition and FIG. 2b is a cross-section illustrating articulated moving components of the grasper;

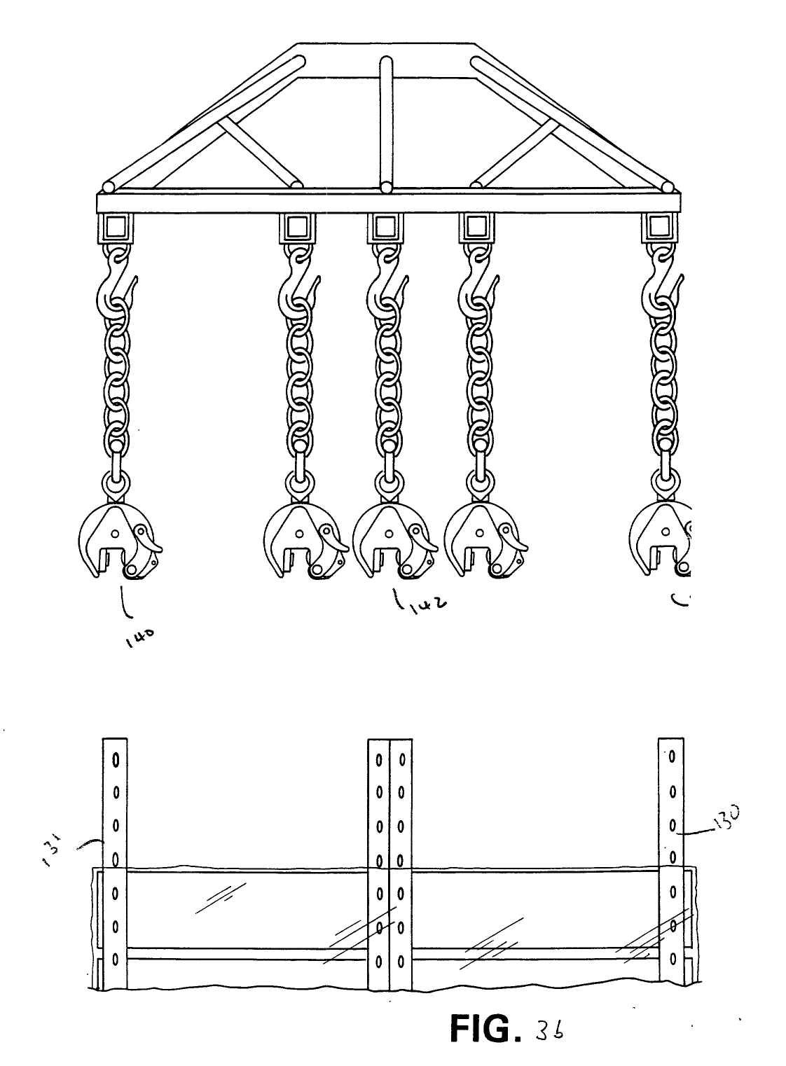

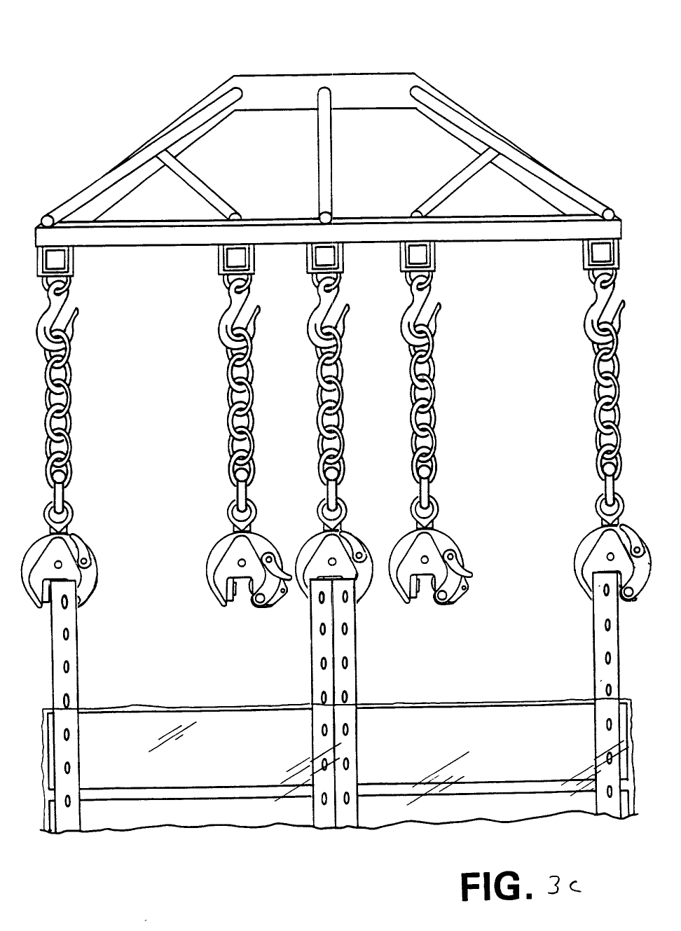

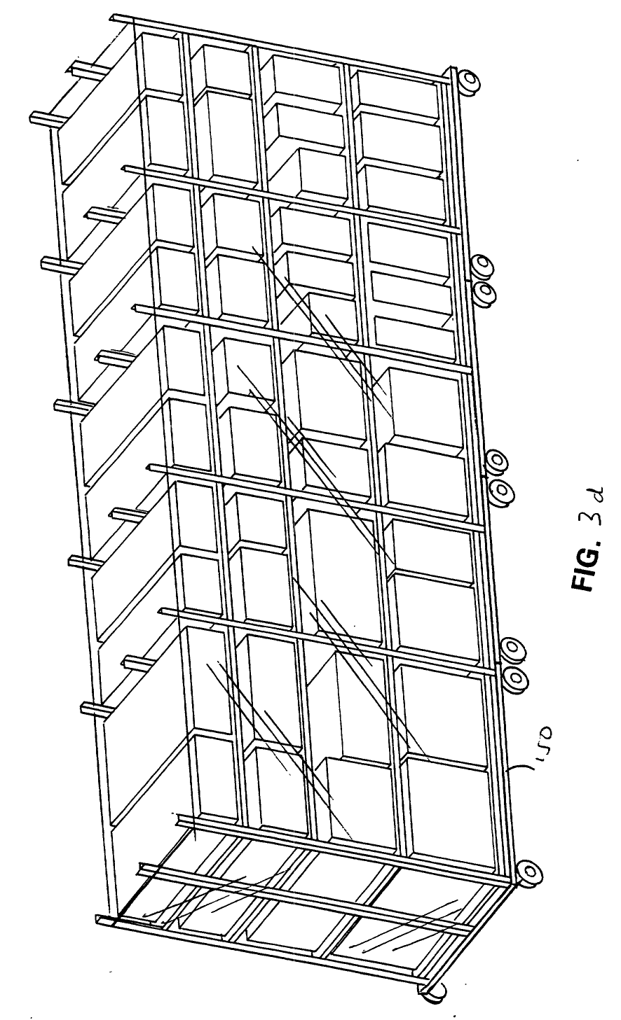

FIG. 3 illustrates wrapping industrial shelving before moving; while FIGS. 3a-3c illustrate locating the rack above the shelving and attaching the rack to the shelving using compression graspers; and FIG. 3d illustrates positioning on a dolly.

### DESCRIPTION

Referring to FIG. 1, a vertical lifting rack 2 includes a rack frame 4 to which are assembled a series of compression graspers, for example, graspers 8. Referring as well to FIGS. 2-2b, a grasper includes a grasper body 20 and, in the open position (FIG. 2), defines a grasping gap 22. The grasping gap 22 is bordered on one side by a moveable compression element 24 and on another side by a stationary non-moveable surface 26. The moveable element 24 may be actuated by a control lever 28. In operation, a portion of the component to be lifted, for example, the vertical post of an industrial shelf is inserted into the gap 22. When lever 28 is rotated in the direction of arrow 29, the moveable component 24 pivots about pivot pin 30 in the direction of arrow 32, closing the gap 22 (FIG. 2a) and forcing by compression the post section in the gap against the stationary surface 26. The contacting surface 34 on the moveable element 24 includes ridges to enhance the frictional contact against the shelving post. In addition, as the shelving is lifted, the weight of the shelving tends to further rotate the moveable member 34 in the direction of arrow 32, which increases the compression force against the shelving post section. Referring particularly to FIG. 2b, the moveable member 24 is articulated to an eccentric control element 25 at a pivot pin 27. The control element 25 has an extension arm 19 connected to a tab 35 attached to the chain ring and, through a spring 31 to a bearing member 33. A pin 17 extends through the tab and extension and travels in a slot 15. The bearing member 33 is rotated about pivot 35 by motion of the lever 28 to a stop pin 39. As a result, as the lever 28 is rotated in the direction of arrow 29, the bearing member 33 rotates in the same direction, which causes the control element 25 to be displaced and movable member 24 to rotate in the direction of arrow 32. The extension arm19 moves downward, causing the tab 35 and attached chain ring to slide downward (arrow 13) in the slot 15. In the closed position, the movable member 24 is biased slightly to create an initial compression loading due to the shape of the member 33 and element 25. A suitable compression grasper, also known as a “dog”, is a steel plate clamp available as Model IPU No. 1622 from Inter Product (USA), Inc., Charlottesville, Va. The unit is made of steel and is rated for a lifting capacity of about 2,000 lbs. and has a maximum gap width of about 20 mm. The Owners/Operators Manual for Inter Product Model IPU Lifting Clamp, is incorporated herein by reference.

Referring back to FIGS. 1 and 1a, the compression graspers are assembled to the lifting rack through chains 9 which are looped over hooks 40 attached to the frame 4. The frame 4 is arranged to permit vertical lifting of the shelving without substantial tipping or bowing, even under uneven strains caused by shelving with unequal loading along its length. The frame 4 includes an assembly portion 50 that extends over the item to be lifted and in this case is generally planar. The assembly portion 50 is constructed of a plurality, in this example, five, substantially parallel metal tube members, 52, 54, 56, 58, 60, along its length to which are attached end cross members 62, 62′, at the ends of the frame, and intermediate cross members 66, 66′, 68, 68′. The hooks 40 are connected to the parallel members though metal tube sections 51 which are slidable (arrow 53) along the members so that the graspers can be positioned at various locations to accommodate shelving of different sizes. At the bottom of the portion 50, a series of cross tubes 74, 75 are provided into which the tines of a forklift may be inserted.

The stability of the rack is enhanced by elements that distribute weight and strain from outlying portions of the rack, particularly near the ends, toward the center. In this example, a stabilizing portion 80 in the form of a truss-work extends out of the plane of the planar portion 50. The stabilizing portion includes a pair of out of plane cross elements 82, 84 near the center of the rack, which rise above the plane of the assembly portion 50. The cross elements 82, 84 are connected by a pair of elements 86, 88. In addition, the cross elements are connected to outer portions of the rack by a series of out of plane angle rods 90, 90′, 91, 91′, 92, 92′, which are connected to the end cross members and angle rods 93, 93′, 94, 94′, which are connected to the intermediate cross members. As a result, the strain on the rack is distributed over its length.

An optional rack extension 100 is illustrated in FIG. 1a. The extension includes a series of parallel bars 101-104 which are sized to slide (arrow 105) into the tube cavity of the parallel members. The extension can carry additional compression graspers to permit lifting longer items. An extension can be used on one or both sides of the rack.

In a particular embodiment, the overall length of the rack, L₁, is about 18½ feet and the overall width, W₁, is about 38 inches (outside to outside). There are five parallel members made of 2×2×¼ inch tube steel. The members are separated by W₂, about 13 inch, W₃, about 19 inch, and W₄, about 25 inches. The end cross members are made of 1¼×1¼×¼ inch steel and the intermediate cross members are made of 1 inch width, ½ inch thick steel. The intermediate cross members are separated by L₂, about 21 inch, and L₃, about 37 inch. The out of plane cross elements are separated by L₄, about 44 inches and are made of 2×2×1¼ inch steel. The out of plane cross elements rise about 1 foot above the plane of the assembly portion. The members 86, 88 connecting the out of plane cross elements along the length of the rack are separated by about 14 inches, and are also made of 2×2×¼ inch tube steel. The connection rods are made of ¾ inch round steel rod. The forklift tubes are made of ¼ inch tube steel in a square cross-section of 2½ inch by 6½ inch. Three sets are provided, approximately centered under the out of plane cross members, providing tine separations of L₆, about 36 inch, L₇, about 30 inch, and L₈, about 24 inch. The rack carries 30 compression graspers and can lift typical industrial shelf loaded weights of around 4,000-8,000 lbs. The maximum lifting capacity is believed to be 20,000 lbs or more. The tube sections 51 are made of ¼ inch steel, have an opening of about 2¼ inches and are about 3 inches long. A U-bolt is welded to the tube section for the hook. The rack can be lifted from below by forklift or from above by a crane. For crane lifting, slings may be wrapped under the out of plane cross-members and/or members 86, 88, and attached to a crane hook. The embodiment described is particularly beneficial for lifting industrial shelving due to the spacing of the parallel members at about 6 and 12 inch spacing, which correspond to the typical width variation of such shelving and also because the graspers can be slid along the length. The rack can be used to lift multiple shelving sections simultaneously, such as two 18 inch width shelves back to back, as will be described below, or multiple shelving sections of different widths, or a single shelving section. The components may be assembled by welding. A preferred rack extension has parallel members that are made of 1½×1½×¼ inch steel tube and have a length of about 4 feet. The extension typically can extend the length of the rack by at least 1½ feet on each side, for a total length of about 21 feet. As evident, the rack permits substantial flexibility in accommodating items of differing length and width and physical configuration and also can be lifted from below or above.

Referring now to FIG. 3, in operation, the shelving is preferably first wrapped without removing the articles from the shelving. The shelving 120 may be, for example, of the type constructed of a series sheet metal post 121 from which are suspended a series of shelves 122. The shelving may be suspended on pins or in other cases bolted to the posts. In this type of shelving, as well as others, the shelving is substantially opened to allow easy access to the items stored on it. The shelving itself may be quite weak structurally and unstable with a load. For example, typical shelving has posts made of 1/16 or ⅛ inch thick sheet metal and shelves of 1/32 to 1/16 inch thick sheet metal. To enhance the rigidity of the shelving, the shelving is wrapped prior to lifting. The wrapping 123 may be stretch wrap sheets or heat shrink material which is fit using a heat gun. It is preferable that the wrap is wound around the shelving horizontally so that the outer shelf post are held together. Alternatively, or, in addition, plastic is positioned over the top of the shelving tent-style. In this case, the posts are preferably punctured through the plastic for easy connection to the rack. The wrap also reduces the chance that items will fall from the shelving during transit and provides a security feature in that an unpierced wrap is indicative that the shelves have not been accessed during transit. Suitable stretch wrap, e.g. 70-120 gauge, and shrink wrap, e.g., 4 to 5 mils, at widths of e.g. 15-30 inches, is available from Rand, Pawtucket, R.I. Other materials can be used for wrapping, such as cloth (e.g. canvas) or metal sheets or belts. The top shelf may be removed in some cases to gain access to the posts.

Referring as well to FIGS. 3a-3c, after wrapping, the lifting rack 2, positioned on a forklift, is moved over the shelving. In this example, two 18 inch width shelving sections 130, 131 are lifted in a back to back configuration using end 140 and middle 142 graspers sets only. The compression graspers are slid (arrow 144) along the bars such that they are generally aligned with the shelving posts. The graspers are then attached to the top of the shelving post.

Referring to FIG. 3d, the shelving can then be lifted by the operator of the forklift and the shelving may be, for example, positioned on a dolly 150 and the rack detached from the shelving. The shelving on the dolly may then easily be rolled to another location in the warehouse. Alternatively, the shelving may be loaded onto a van for relocation to a different facility. The shelving may then be removed from the dolly using the rack as described above.

Still further embodiments are with in the following claims.

What is claimed is:

1. A method for lifting shelving, comprising:
providing a vertical lifting rack arranged to be positioned above the shelving to be lifted, the rack including a compression grasper for attachment to the article when the rack is positioned thereover and capable of maintaining attachment as the shelving is lifted,
positioning the rack over the shelving,
attaching the rack to the shelving by attaching the compression grasper, and
lifting the shelving by lifting the rack.

2. The method of claim 1 wherein the compression grasper includes a moveable compression element that increases compression forces as the article is lifted vertically.

3. The method of claim 2 wherein the moveable element is a pivoting element.

4. The method of claim 3 wherein the grasper includes a single moveable compression element that provides compression force against a non-moveable surface.

5. The method of any one of claims 1-4 wherein the shelving includes a series of metal posts and the grasper is attached to the post.

6. The method of claim 5 wherein the posts are metal posts having a thickness of about ⅛ inch or less.

7. The method of claim 6 wherein the rack includes a series of compression graspers for attachment to multiple posts.

8. The method of claim 1 comprising:
prior to lifting the shelving, providing plastic wrap around portions of the shelving including articles.

9. The method of claim 1 comprising:
lifting the shelving and placing the shelving on a rolling dolly.

10. The method of claim 9 comprising:
rolling the shelving to a new location.

11. The method of claim 10 comprising:
rolling the shelving into a vehicle.

12. The method of claims 10 or 11 comprising:
lifting the shelving from the rolling dolly using said vertical lifting rack.

13. A vertical lifting rack, comprising:
a lifting frame arranged to be positioned above an article to be lifted, the frame including a compression grasper for attachment to the article when the frame is positioned thereover and capable of maintaining attachment as the article is lifted.

14. The rack of claim 13 wherein the compression grasper includes a moveable compression element that increases compression force as the article is lifted vertically.

15. The rack of claim 14 wherein the moveable element is a pivoting element.

16. The rack of claim 15 wherein the grasper includes a single moveable element that provides compression force against a non-moveable surface.

17. The method of claim 16 wherein the rack is forklift compatible.
